(19) United States
(12) Patent Application Publication
(10) Pub. No.: US 2008/0139241 A1
(43) Pub. Date: Jun. 12, 2008

(54) Mobile radio terminal

(75) Inventor: Moriaki Kiyomoto, Kokubunji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/903,184

(22) Filed: Sep. 20, 2007

(30) Foreign Application Priority Data
Dec. 6, 2006 (JP) 2006-329520

(51) Int. Cl. H04Q 7/20

(52) U.S. Cl. 455/552.1

(57) ABSTRACT

If an outgoing call is generated, a control unit discriminates on the basis of various tables stored in a memory unit whether or not a system waiting for incoming calls is set with top priority in PRL, whether or not the outgoing call is an outgoing call of a preset type, whether or not the system is roaming, whether or not the system waiting for incoming calls is a system set to execute re-selection, whether or not the outgoing call is an outgoing call for which a system of higher priority is set, and re-selects the system employed for outgoing call if necessary. In addition, at the re-selection, the control unit limits the time for re-searching of the standby systems and the number of the searched systems in accordance with the outgoing call type.

### CROSS-REFERENCE TO RELATED APPLICATIONS

This application is based upon and claims the benefit of priority from prior Japanese Patent Application No. 2006-329520, filed Dec. 6, 2006, the entire contents of which are incorporated herein by reference.

### BACKGROUND OF THE INVENTION

1. Field of the Invention

The present invention relates to a mobile radio terminal capable of establishing radio communication by selectively using a plurality of mobile communication networks.

2. Description of the Related Art

A conventional mobile radio terminal such as a cellular telephone can acquire merits of service such as charges, communication quality and the like by signing contracts with a plurality of carriers and selectively using them (cf. for example, JP-A No. 2005-057518 (KOKAI)).

In addition, if a certain period has elapsed when the power is turned on or when the conventional mobile radio terminal is in standby status, or in an out-of-service area, or if the system is lost when conversation is ended or when the conventional mobile radio terminal is in standby status, the available systems such as carriers, frequency bands (communication schemes) and the like are reconsidered. In such a case, however, a problem arises that carriers or communication schemes having great merits for the user are not always selected.

This problem can also arise, not only when the user is under contract with a plurality of carriers, but also when the user is in an environment which allows the user to simultaneously use the system of the carrier under contract and the system of a carrier to which the user can connect by roaming and when the user establishes communication by selectively using either a 800 MHz system or a 2 GHz system upon using one carrier.

In a conventional mobile radio terminal, systems having great merits for the user are not always employed.

### BRIEF SUMMARY OF THE INVENTION

The present invention has been accomplished to solve the above-described problems. The object of the present invention is to provide a mobile radio terminal capable of enhancing usability by certainly making outgoing calls in a system which has great merits.

To achieve this object, an aspect of the present invention is a mobile radio terminal, establishing radio communication with base stations accommodated in a plurality of different mobile radio communication systems, respectively. The terminal comprises: a communication unit configured to selectively establish radio communication with the base stations accommodated in a plurality of different mobile radio communication systems, respectively; a memory unit configured to store a list of association of identification information of the plurality of different mobile radio communication systems with priorities; an outgoing call detector configured to detect an outgoing call request; a system detector configured to control the communication unit to detect the mobile radio communication system having higher priority and being capable of communication, in the list stored in the memory unit if the outgoing call detector detects the outgoing call request; and an outgoing call controller configured to control the communication unit to generate an outgoing call via the mobile radio communication system detected by the system detector.

According to the present invention, a list of association of the identification information of the plurality of different mobile radio communication system with priorities is stored preliminarily. If an outgoing call request is detected, the mobile radio communication system having a higher priority and being capable of communication is detected on the basis of the list and an outgoing call is generated via the detected mobile radio communication system.

Thus, if an outgoing call request is detected, a desired system can be selected certainly as the outgoing call is generated by employing the mobile radio communication system having a higher priority and being capable of communication.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a mobile radio terminal according to an embodiment of the present invention;

FIG. 2 is a table showing PRL stored in the mobile radio terminal shown in FIG. 1;

FIG. 3 is a call type responsive re-selection possibility table stored in the mobile radio terminal shown in FIG. 1;

FIG. 4 is a roaming responsive re-selection possibility table as stored in the mobile radio terminal shown in FIG. 1;

FIG. 5 is a standby system responsive re-selection possibility table as stored in the mobile radio terminal shown in FIG. 1;

FIG. 6 is a call type responsive priority system table as stored in the mobile radio terminal shown in FIG. 1;

FIG. 7 is a call type responsive parameter table as stored in the mobile radio terminal shown in FIG. 1;

FIG. 8 is a flowchart describing a call system re-selection process, of the mobile radio terminal shown in FIG. 1;

FIG. 9 is a table showing PRL stored in the mobile radio terminal shown in FIG. 1; and

FIG. 10 is a table showing PLMN stored in the mobile radio terminal shown in FIG. 1.

### DETAILED DESCRIPTION OF THE INVENTION

Embodiments of the present invention will be described with reference to the accompanying drawings.

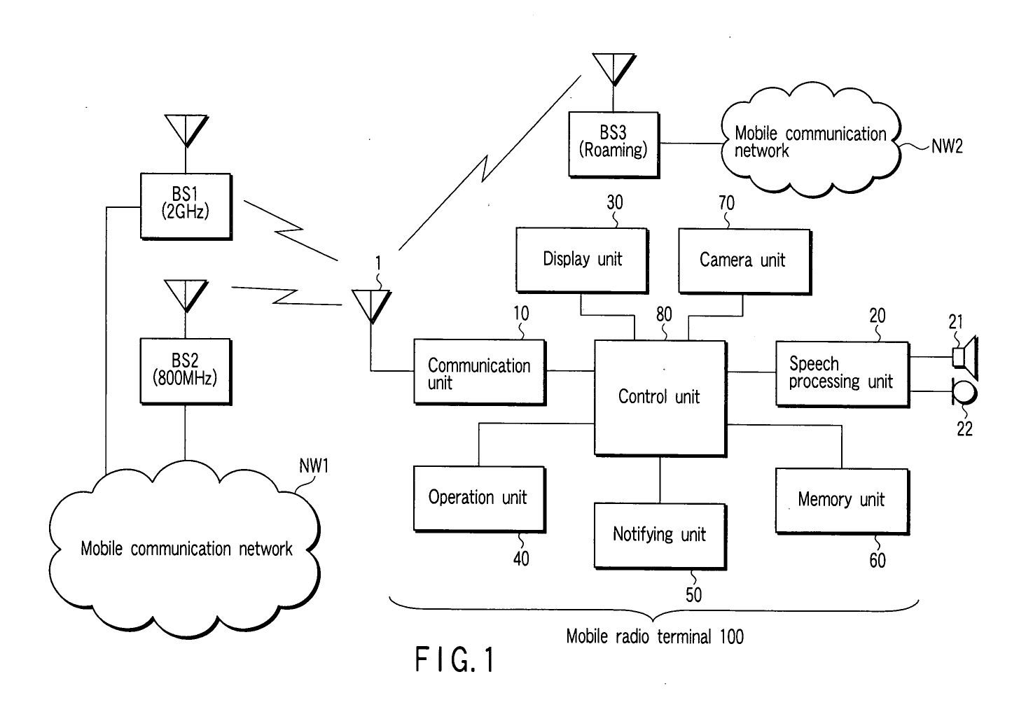

FIG. 1 shows a configuration of a mobile radio terminal 100 according to an embodiment of the present invention. The mobile radio terminal 100 comprises an antenna 1, a communication unit 10, a speech processing unit 20, a display unit 30, an operation unit 40, a notifying unit 50, a memory unit 60, a camera unit 70, and a control unit 80. The mobile radio terminal 100 implements speech communications and data communications by conducting radio communications with radio base stations BS1, BS2, BS3 and the like.

BS1 and BS2 are radio base stations of a carrier (hereinafter called a contract carrier) with which the mobile radio terminal 100 is under contract, and are accommodated in a mobile communication network NW1 of the contract carrier. The radio base station BS1 conducts radio commutations with the mobile radio terminal 100 over a 2 GHz band. The radio base station BS2 conducts radio commutations with the mobile radio terminal 100 over a 800 MHz band.

BS3 is a radio base station of a carrier (hereinafter called a roaming carrier) which can execute roaming with the contract carrier, and is accommodated in a mobile communication network NW2 of the roaming carrier to execute radio communications with the mobile radio terminal 100 by roaming.

Only one base station is shown, but the roaming carrier also comprises a radio base station of 800 MHz band and a radio base station of 2 GHz band similarly to the contract carrier.

The antenna 1 receives radio signals transmitted from the radio base stations BS1 to BS3, and sends radio signals from the mobile radio terminal 100 to the radio base stations BS1 to BS3.

The communication unit 10 establishes radio communications with the radio base stations BS1 to BS3 via the antenna 1, and executes communications in the mobile communication networks NW via the radio base stations BS1 to BS3. In addition, the communication unit 10 selectively sends and receives the radio signals of the 800 MHz band or the 2 GHz band, in a communications protocol according to a direction of the control unit 80.

More specifically, the communication unit 10 down-converts and demodulates the radio signals received by the antenna 1, to obtain data sent from a partner station. In addition, the communication unit 10 modulates the baseband signals with the data supplied from the control unit 80, generates radio signals by up-converting the baseband signals, and sends the generated radio signals to the radio base stations BS1 to BS3 via the antenna 1.

The speech processor 20 regenerates speech signals by decoding encoded speech data included in the data demodulated by the communication unit 10, and outputs the speech signals from a built-in speaker 21. The speech sent from the partner station is thereby transmitted to the user. In addition, the speech processor 20 generates encoded speech data by encoding speech signals input from a built-in microphone 22, and supplies the generated encoded speech data to the communication unit 10 via the control unit 80.

The display unit 30 is a display unit which employs an LCD (Liquid Crystal Display) or the like to display to the user various kinds of visual information such as texts, images, images taken by the camera unit 70, videophone images received from the partner station and the like. The operating unit 40 comprises a plurality of key switches to accept user's requests. The notifying unit 50 notifies the user of incoming calls by sounds.

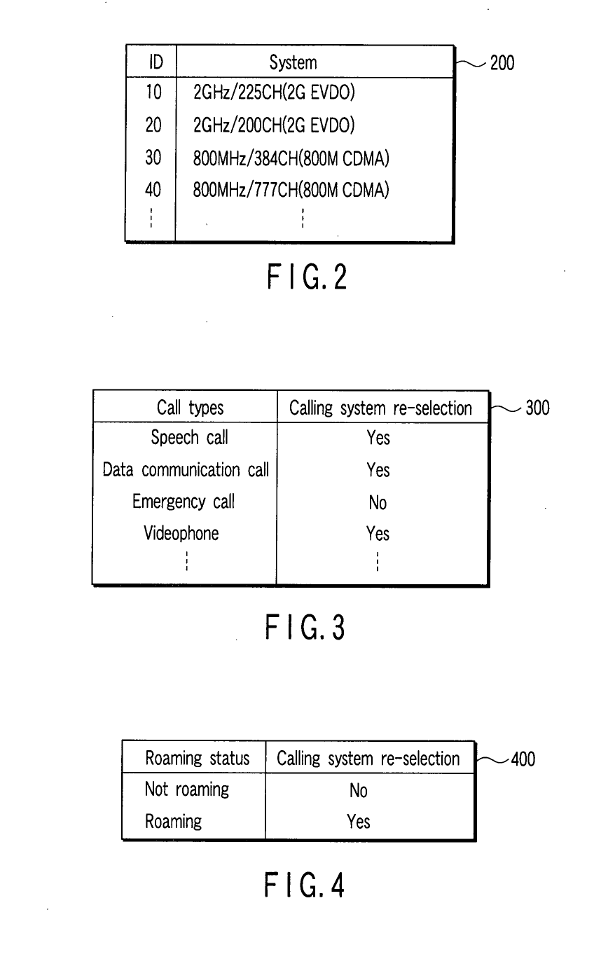

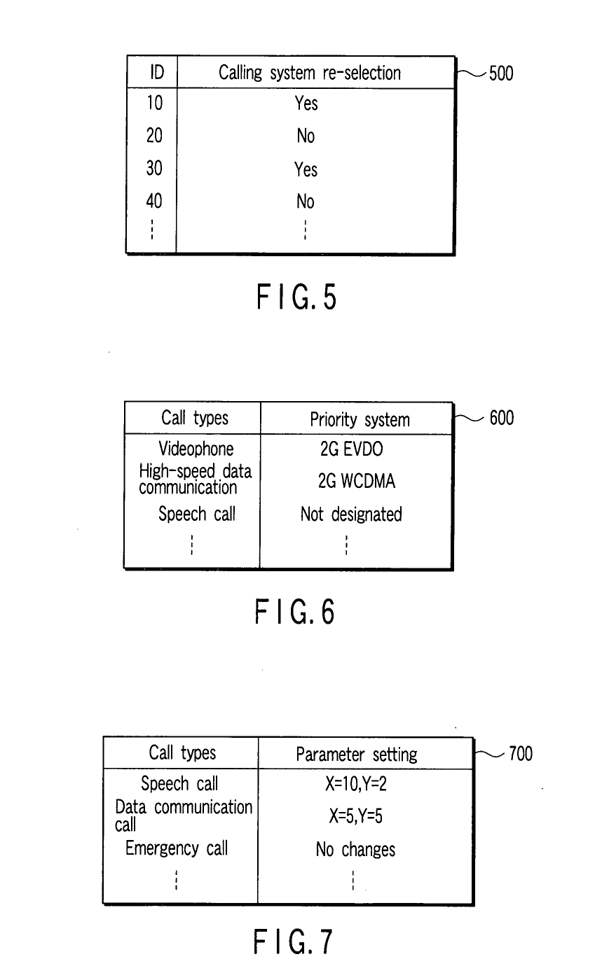

The memory unit 60 stores control programs and control data of the control unit 80, and data concerning the communication control received from the radio base stations BS1 to BS3. As for the control data, the memory unit 60 stores a PRL (Preferred Roaming List) 200 providing as roaming information the identification information, bands and channels of systems to be employed for communications, in order of higher priorities, in association with roaming identification information (not shown) indicating whether or not the communication is roaming, as shown in FIG. 2, a call type responsive re-selection possibility table 300 indicating whether or not an outgoing call system re-selection process to be described later should be conducted, in response to the call type, as shown in FIG. 3, a roaming responsive re-selection possibility table 400 indicating whether or not the outgoing call system re-selection process should be conducted, in response to the roaming status, as shown in FIG. 4, a standby system responsive re-selection possibility table 500 indicating whether or not the outgoing call system re-selection process should be conducted, in response to a system employed currently in the standby status, as shown in FIG. 5, a call type responsive priority system table 600 providing the type of the system having priority as the standby system in response to the type of calls, as shown in FIG. 6, and a call type responsive parameter table 700 providing parameters to be used in the outgoing call system re-selection process in response to the type of calls, as shown in FIG. 7.

In addition, the memory unit 60 stores telephone directory data associated with telephone numbers, names and image data such as face pictures, and mail data which have been sent and received.

The camera unit 70 is a digital camera comprising image pickup devices such as CCD (Charge-Coupled Device), CMOS (Complementary Metal Oxide Semiconductor) or the like, to take still images and videophone moving images.

The control unit 80 controls all the units of the mobile radio terminal 100, and operates on the basis of the control programs and control data stored in the memory unit 60. For example, the control unit 80 comprises an incoming call controlling function of controlling the communication unit 10 to receive incoming signals from the radio base stations BS of the system which is to wait for incoming signals, under a predetermined communication protocol, controlling the display unit 30 and the notifying unit 50 to notify the user of occurrence of the incoming signals upon receipt of the incoming signals, urging the communication unit 10 to send signals responding to the incoming signals, and establishing a communication link for executing the speech communication and videophone.

In addition, the control unit 80 also comprises a function of controlling the communication unit 10 to search the systems in the PRL 200 in order of higher priorities and detect the system to be employed in the standby status (hereinafter called standby system) when the power supply is turned on, when a certain period has elapsed in a case where the terminal is in the standby status or out of the service area, when the communication is ended, and when the system in the standby status is lost.

When the control unit 80 receives a request for outgoing calls from the user via the operating unit 40, the control unit 80 determines the system to be employed for the communications by executing the outgoing call system re-selection process, controls the communication unit 10 to establish radio communications with the radio base station of the determined system, and executes the communication of the type which the user wishes. Details of the operation will be described later.

Besides the control functions for implementing the speech communication, the control unit 80 further comprises a control function of controlling the communication unit 10 to implement videophone to send and receive speech and images with the communication partner, a browser function of urging the display unit 30 to display the data provided by the server and allowing the user to browse the data, a function of sending and receiving electronic mails, and the like.

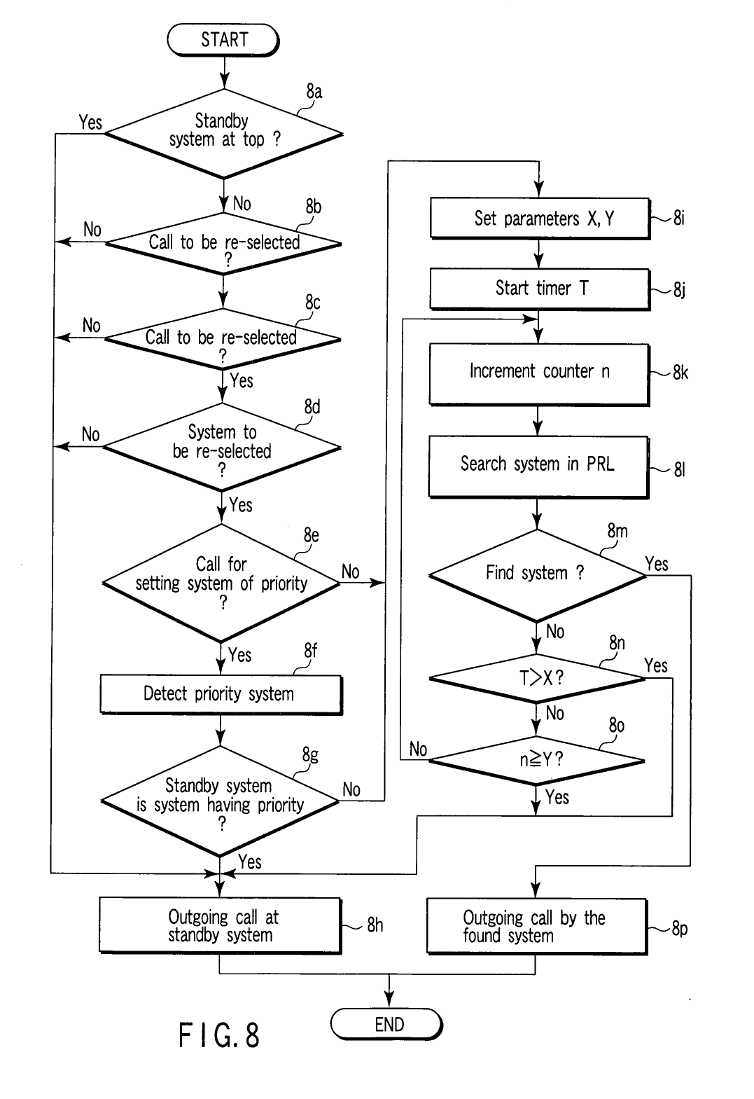

Next, operations of the mobile radio terminal having the above-described configuration will be described. The following descriptions are focused on the outgoing call system re-selection process. This process is implemented by executing control of a flowchart shown in FIG. 8 by the control unit 80 on the basis of the control programs and control data stored in the memory unit 60 when the control unit 80 accepts the request for outgoing calls from the user.

First, in step 8a, the control unit 80 refers to the PRL 200 and discriminates whether or not the standby system is set at the top in the PRL 200. If the standby system is set at the top, the control unit 80 shifts to step 8h. If the standby system is not set at the top, the control unit 80 shifts to step 8b.

In step 8b, the control unit 80 detects the type of the outgoing call (speech call, videophone, data communication call, high-speed data communication, emergency call and the like) on the basis of the user operation which causes the outgoing call system re-selection process to be started. Then, the control unit 80 refers to the call type responsive re-selection possibility table 300 and discriminates whether or not the detected type of the outgoing call is the call by which re-selection of the standby system should be executed. If the detected type of the outgoing call is the call by which re-selection of the standby system should be executed, the control unit 80 shifts to step 8c. If the detected type of the outgoing call is the call by which re-selection of the standby system should not be executed, the control unit 80 shifts to step 8h.

The call type responsive re-selection possibility table 300 shown in FIG. 3 is set not to execute the re-selection of the standby system only when the detected type of the outgoing call is the emergency call. Therefore, in the present embodiment, the control unit 80 shifts to step 8h only when the detected type of the outgoing call is the emergency call, i.e. the outgoing call for a police station and a fire station, a preset emergency contact address and the like. This discrimination is made with reference to the telephone number which is preset as the emergency call or, if the emergency call is made when a specific key is pushed down, the discrimination is made on the basis of pushing down the specific key.

In step 8c, the control unit 80 discriminates, on the basis of the PRL 200, whether or not the current standby system is a system based on roaming, i.e. whether or not the mobile radio terminal is currently in the standby status due to roaming. Then, the control unit 80 discriminates on the basis of the roaming responsive re-selection possibility table 400 whether or not the current roaming status is a roaming status in which re-selection of the standby system should be executed. If the current roaming status is a roaming status in which re-selection of the standby system should be executed, the control unit 80 shifts to step 8d. If the current roaming status is a roaming status in which re-selection of the standby system should not be executed, the control unit 80 shifts to step 8h.

In the roaming responsive re-selection possibility table 400 shown in FIG. 4, the re-selection of the standby system is set not to be executed in the non-roaming status and set to be executed in the roaming status. Therefore, in this case, if the standby system is in the standby status due to the roaming, the control unit 80 shifts to step 8d. If the standby system is not in the standby status due to the roaming, the control unit 80 shifts to step 8h.

In step 8d, the control unit 80 discriminates, on the basis of the standby system responsive re-selection possibility table 500 shown in FIG. 5, whether or not the current standby system is a system in which re-selection of the standby system should be executed. If the current standby system is a system in which re-selection of the standby system should be executed, the control unit 80 shifts to step 8e. If the current standby system is a system in which re-selection of the standby system should not be executed, the control unit 80 shifts to step 8h.

In step 8e, the control unit 80 discriminates, on the basis of the call type responsive priority system table 600 shown in FIG. 6, whether or not the type of the call detected in step 8b is the type for which the type of the system having priority as the standby system is set. If the type of the call detected in step 8b is the type for which the type of the system having priority as the standby system is set, the control unit 80 shifts to step 8f. If the type of the call detected in step 8b is the type for which the type of the system having priority as the standby system is not set, the control unit 80 shifts to step 8i.

In step 8f, the control unit 80 detects the type of the call detected in step 8b as the type of the system having priority as the standby system by referring to the call type responsive priority system table 600, and shifts to step 8g.

In step 8g, the control unit 80 discriminates whether or not the standby system is the system having priority detected in step 8f, by referring to the PRL 200. If the standby system is the system having priority, the control unit 80 shifts to step 8h. If the standby system is not the system having priority, the control unit 80 shifts to step 8i.

In step 8h, the control unit 80 controls the communication unit 10 to generate an outgoing call using the standby system, and ends the process.

In step 8i, the control unit 80 reads parameters X and Y corresponding to the type of the call detected in step 8b by referring to the call type responsive parameter table 700 shown in FIG. 7, and shifts to step 8j.

In step 8j, the control unit 80 starts timer T, starts measurement of the elapsing time and resets the value of the counter n to “0”, and shifts to step 8k. The timer T corresponds to a timer which measures an elapsing time of a loop process in steps 8k to 8o to be described later (process of re-searching the standby system) and the counter n indicates the value corresponding to the loop times of the loop process.

In step 8k, the control unit 80 increments the value of counter n by “1”, and shifts to step 8l.

In step 8l, the control unit 80 controls the communication unit 10 to refer to the PRL 200, receive a signal from the system having higher priority corresponding to the count value of the counter n and search the system, and shifts to step 8m.

In step 8m, the control unit 80 discriminates whether or not the system could be founded, i.e. whether or not the system having higher priority could be founded as a result of the search in step 8l. If the system having higher priority could be founded, the control unit 80 shifts to step 8p. If the system having higher priority could not be founded, the control unit 80 shifts to step 8n.

In step 8n, the control unit 80 discriminates whether or not the measured time of timer T has exceeded the parameter X read in step 8i. If the measured time of timer T has exceeded the parameter X, the control unit 80 shifts to step 8h. If the measured time of timer T is equal to or shorter than the parameter X, the control unit 80 shifts to step 8o. In other words, if a predetermined time has elapsed after the process of re-searching the standby system started, the control unit 80 shifts to step 8h. If a predetermined time has not elapsed, the control unit 80 shifts to step 8o.

In step 8o, the control unit 80 discriminates whether or not the count value of the counter n is equal to or greater than the parameter Y read in step 8i, the control unit 80 shifts to step 8h. If the count value is smaller than Y, the control unit 80 shifts to step 8k.

In step 8p, the control unit 80 controls the communication unit 10 to regard the system found in step 8l as the standby system, generates an outgoing call using this system, and ends this process.

In the mobile radio terminal, as described above, when the user makes a request for outgoing call, the process of re-searching the standby system is executed. Upon the outgoing call, the system which the user desires can be selected certainly.

In addition, if the standby system is the system which has already been set at the top of the PRL 200, the re-searching process is not executed but the outgoing call is generated by the current standby system. For this reason, the outgoing call is not delayed by the re-searching process.

As for the outgoing call of the type such as the emergency call for which the setting of not preliminarily executing the re-searching process is made in the call type responsive re-selection possibility table 300 as shown in, for example, FIG. 3, the re-searching process is not executed but the outgoing call is generated by the current standby system. For this reason, the outgoing call is not delayed by the re-searching process.

In a case where the standby system is in the roaming status (non-roaming in FIG. 4) for which the setting of not executing the re-searching process is made in the roaming responsive re-selection possibility table 400 as shown in, for example, FIG. 4, the re-searching process is not executed but the outgoing call is generated by the current standby system. For this reason, the outgoing call is not delayed by the re-searching process.

In a case where the standby system is the system for which the setting of not executing the re-searching process is made in the standby system responsive re-selection possibility table 500 as shown in, for example, FIG. 5, the re-searching process is not executed but the outgoing call is generated by the current standby system. For this reason, the outgoing call is not delayed by the re-searching process.

In a case where the type of the generated outgoing call is the outgoing call of the type for which the priority system is set in the call type responsive priority system table 600, the re-searching process is not executed but the outgoing call is generated by the current standby system if the currently standby system is not the system set to have the top priority in the PRL 200 but the system of the type corresponding to the type of the outgoing call. For this reason, the outgoing call is not delayed by the re-searching process.

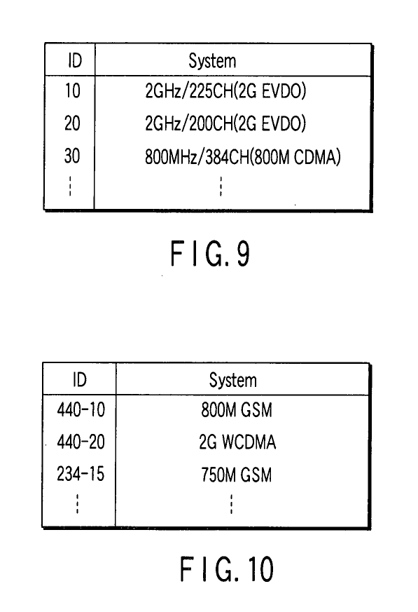

For example, when the PRL 200 is a table shown in FIG. 9, the standby system is indicated by ID 20. If the user generates the outgoing call of videophone, “2 GHz band EVDO” is set for the videophone in the call type responsive priority system table 600 as shown in, for example, FIG. 6.

As shown in FIG. 9, the system of ID 10 having higher priority than the standby system (ID 20) exists in the PRL 200. In addition, this system is the 2 GHz band EVDO scheme”, but the standby system of ID 20 is in the “2 GHz band EVDO” in which the videophone is set in the call type responsive priority system table 600. For this reason, the control unit 80 does not execute the re-searching process but generates the outgoing call in the standby system ID 20. Thus, the outgoing call is not delayed, and desired communication qualities can be obtained.

In addition, as the time for searching by the re-searching process of the standby system and the number of systems are limited in accordance with the type of the generated outgoing call, it is possible to delay the outgoing call by continuously repeating the re-searching process.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

In the above-described embodiment, for example, the PRL 200 is shown as the list of the priorities in the standby system by assuming the CDMA 2000-based system, but the present invention is not limited to this. In a W-CDMA (Wideband Code Division Multiple Access)/GSM (Global System for Mobile communication)-based system, for example, the re-searching process of the standby system may be executed upon generation of the outgoing call, on the basis of a PLMN (Public Land Mobile Network) as shown in FIG. 10.

The present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal, establishing radio communication with base stations accommodated in a plurality of different mobile radio communication systems, respectively,
the terminal comprising:
a communication unit configured to selectively establish radio communication with the base stations accommodated in a plurality of different mobile radio communication systems, respectively;
a memory unit configured to store a list of association of identification information of the plurality of different mobile radio communication systems with priorities;
an outgoing call detector configured to detect an outgoing call request;
a system detector configured to control the communication unit to detect the mobile radio communication system having higher priority and being capable of communication, in the list stored in the memory unit if the outgoing call detector detects the outgoing call request; and
an outgoing call controller configured to control the communication unit to generate an outgoing call via the mobile radio communication system detected by the system detector.

2. The terminal according to claim 1, wherein if a mobile radio communication system employed for standby for incoming calls is currently set to have highest priority in the list stored in the memory unit, the outgoing call controller generates an outgoing call via the mobile radio communication system employed for standby for incoming calls.

3. The terminal according to claim 1, wherein if the outgoing call request detected by the outgoing call detector is generated for a preset partner, the outgoing call controller generates an outgoing call via the mobile radio communication system currently employed for standby for incoming calls.

4. The terminal according to claim 1, further comprising a roaming information memory unit configured to store a list of association of the identification information of the plurality of different mobile radio communication systems with information indicating roaming,
wherein the outgoing call controller discriminates whether or not the mobile radio communication system currently employed for standby for incoming calls is roaming, in accordance with the list stored in the roaming information memory unit, and generates an outgoing call in accordance with a result of the discrimination.

5. The terminal according to claim 1, wherein the outgoing call controller discriminates whether or not the mobile radio communication system currently employed for standby for incoming calls is a preset system, and generates an outgoing call in accordance with a result of the discrimination.

6. The terminal according to claim 1, further comprising a communication type detector configured to detect a communication type of the outgoing call request detected by the outgoing call detector,
wherein the outgoing call controller discriminates the communication type detected by the communication type detector, and generates an outgoing call in accordance with a result of the discrimination.

7. The terminal according to claim 1, further comprising a communication type detector configured to detect a communication type of the outgoing call request detected by the outgoing call detector,
wherein if the outgoing call detector detects the outgoing call request, the system detector controls the communication unit in accordance with the list stored in the memory unit to execute the process of detecting the mobile radio communication system having higher priority and being capable of communication, at number of times corresponding to the communication type detected by the communication type detector.

8. The terminal according to claim 1, further comprising a communication type detector configured to detect a communication type of the outgoing call request detected by the outgoing call detector,
wherein if the outgoing call detector detects the outgoing call request, the system detector controls the communication unit in accordance with the list stored in the memory unit to execute the process of detecting the mobile radio communication system having higher priority and being capable of communication, during a period corresponding to the communication type detected by the communication type detector.
